(19) United States
(12) Patent Application Publication
(10) Pub. No.: US 2004/0155735 A1
(43) Pub. Date: Aug. 12, 2004

(54) Circuit breaker

(76) Inventors: Joerg-Uwe Dahl, Werder (DE); Michael Kruschke, Schwante (DE); Andreas Kaeding, Falkensee (DE); Marc Liebetruth, Glienicke (DE); Detlev Schmidt, Berlin (DE)

Correspondence Address: HARNESS, DICKEY & PIERCE, P.L.C., P.O.BOX 8910, RESTON, VA, 20195, US

(21) Appl. No.: 10/740,536

(22) Filed: Dec. 22, 2003

(30) Foreign Application Priority Data
Dec. 20, 2002 (DE) 10261855.0

(51) Int. Cl. H01H 75/00

(52) U.S. Cl. 335/16

(57) ABSTRACT

A circuit breaker includes at least two stationary contact devices, at least two movable contact devices and at least one drive device. The at least one drive device is operatively connected to the at least two moving contact devices. The contact-making between at least one stationary contact device and at least one moving contact device and the contact-making between at least one further stationary contact device and at least one further moving contact device each take place at different times during the connection process.

The present application hereby claims priority under 35 U.S.C. § 119 on German patent application number DE 102 61 855.0 filed Dec. 20, 2002, the entire contents of which are hereby incorporated herein by reference.

### FIELD OF THE INVENTION

The invention generally relates to a circuit breaker.

### BACKGROUND OF THE INVENTION

Specifically designed switching apparatuses are required for switching high voltages and currents, and these can generally be combined under the term circuit breaker. The configuration of all such circuit breakers essentially includes one or more stationary contact devices and one or more moving contact devices, and at least one drive unit, which is operatively connected to the moving contact devices. The drive unit allows the moving contact devices to be connected to and disconnected from stationary contact devices, which results in closing or opening of the circuits which are connected to the contact devices.

A defined switching characteristic must be achieved in order to provide a highly selective circuit breaker, and this is dependent on exact dimensioning of the circuit breaker. The drive forces in highly selective circuit breakers are dimensioned for a connection process in the event of a short circuit. The drive energy which is required for connection of the circuit breaker is used partially to overcome mechanical forces, with the remainder being used to overcome electrodynamic current loop forces. It is desirable to reduce the drive energy that is required, since this allows smaller dimensioning of the drive, transmission, latching and contact devices.

One known measure for reducing the electrodynamic component is to optimize the current loop. This has the disadvantage that this compensates for the fact that the current loop has a compensating effect on the desired current.

Optimization of the mechanical component is also known from DE 100 48 659 A1. In this case, it is proposed that two contact force springs, which act at different switching positions, be provided in order to ensure an advantageous switching path dependency for the force that is required for connection. This has the disadvantage that the addition of the switching forces that are required for the moving switching contacts to make at the same time results in a high total force, which represents a major barrier for the drive mechanism.

According to DE 101 37 422 C1, it is known, in the case of a drive (which is in the form of a toggle lever system) for the contact mount, for the point at which the coupling rod acts on the contact mount to be designed to be adjustable with respect to the rotation point of the contact mount. The aim of this is to keep the torque on the drive shaft constant, although the contact force of the individual contact mounts can be adjusted.

According to DE 299 17 860 U1, on the one hand, the contact force can be adjusted just by the variability of the length of the coupling rod, that is to say via the contact travel.

Furthermore, according to DE 40 06 452 C2, the contact travel is variable, to be precise simply by reinsertion of a hinge point on a coupling lever. As such, the required contact separation can be chosen for two rated voltages.

DE 198 56 773 C2 discloses a drive for a high-voltage circuit breaker with a transmission, whose drive lever arm is connected to the coupling rod via a further lever, which has a guide in which the drive lever arm can be moved. If the drive lever arms of the switch poles are rotated through a few degrees with respect to one another, then different speed profiles can be achieved for the switch poles during the switching movement. However, the switching movement starts and ends at the same time.

With respect to the switching forces at the end of the switching movement, the problem of a correspondingly high total force still remains, with all of these solutions.

DE 195 25 286 C2 discloses a multipole vacuum interrupter, in which the electromagnetic influence (which occurs in particular in this case) between adjacent vacuum tubes which reduces the switching capacity, is reduced in that the central interrupter is opened before the outer interrupters during opening of the switch. The outer interrupters, which are further away from one another, can then be opened at the same time, since they have less influence on one another. In the case of mechanical circuit breakers without vacuum interrupters, it is, in fact, the current loop forces within the phases themselves which, on the other hand, have to be coped with.

### SUMMARY OF THE INVENTION

An embodiment of the invention includes an object of providing a circuit breaker, which includes an improved connection capacity and/or which needs less energy for connection.

According to an embodiment of the invention, an object may be achieved by a circuit breaker. The circuit breaker includes at least two stationary contact devices, at least two contact devices which can move relative to them and at least one drive device. Further, the contact-making between at least one stationary contact device and at least one moving contact device and the contact-making between at least one further stationary contact device and at least one further moving contact device take place at different times during the connection process.

By having contact making occur at different times, this reduces the maximum force in the force profile resulting from the addition of all the individual contact switching forces. This advantageously results in a reduction in the maximum drive force that is required, which makes it possible to reduce the energy that is required by the circuit breaker during the connection process. This allows the drive, transmission, latching and contact devices to be dimensioned to be smaller. Furthermore, the reduced and broadened force maximum results in the circuit breaker having an improved connection capacity.

One embodiment of the invention provides for the drive device to include a switching shaft, by which a torque can be transmitted in a manner which is particularly simple to handle to two or more contact devices. Provision is furthermore preferably made for the switching shaft to include at least one switching shaft lever which is preferably connected to the switching shaft. The use of at least one switching shaft lever allows positioning along a greater positioning travel for the same switching shaft positioning angle.

Furthermore, one embodiment of the invention provides for the drive device to include at least two coupling devices, each of which is operatively connected to one of the switching shaft levers and to one of the moving contact devices. This provides the capability for transmission of the drive torque over a greater distance than would be feasible by way of shaft cantilever arms on their own. In particular, provision is preferably made for at least one coupling device to include a coupling rod, which offers the capability to transmit force in a manner which can be handled particularly easily.

Provision is also made in a particularly preferred manner for the coupling points of the at least one switching shaft lever for coupling of the coupling devices to be in mutually different positions with respect to the switching shaft axis. This can be achieved, for example, by different angular positions of the corresponding switching shaft levers. This results in one moving contact device lagging behind another, which leads to the contact devices making at different times. In consequence, the individual drive forces for the contact devices are also added with a time offset, which, in the end, considerably reduces the maximum total force and allows the drive, transmission, latching and contact devices to be dimensioned to be smaller.

This can also be achieved by at least two coupling rods preferably having different lengths to one another. As such, different positioning movements of the contact devices are achieved for the same positioning angle of the switching shaft. This once again results in the contacts of the corresponding contact devices making at different times.

In particular, provision can preferably be made for all of the coupling points to the coupling device of the switching shaft levers to be in the same position with respect to the switching shaft axis, in a preferred manner with a different coupling rod length. This allows the range of components for the switching shaft, for example when using the same switching shaft configuration for different embodiments of circuit breakers, to be reduced. Provision can likewise advantageously be made for all of the coupling rods to have the same length, with the making of the moving contact devices at different times being achievable, for example, by different positioning of the coupling points to the coupling device of the switching shaft lever with respect to the switching shaft axis. Thus, the range of components for the coupling rod can be minimized and manufacturing errors resulting from incorrect coupling rods being fitted can be avoided.

In one embodiment of the invention, for example for the switching of three-phase devices, the circuit breaker includes a three-pole configuration. Furthermore, for example for the switching of three-phase devices with a neutral conductor, the circuit breaker includes a four-pole configuration.

Finally, one embodiment of the invention provides for the time at which the contacts of one pole make and the time at which the contacts of the other poles make during the connection process to differ from one another, in a particularly preferably manner such that the times at which the contacts of the three poles touch during the connection process differ from one another and, particular preferably such that the times at which the contacts of all the poles make during the connection process differ from one another. Since the drive forces which are required to switch the individual poles are additive, it is advantageous for at least two, but best of all all, of the contact devices to make at different times, since this makes it possible to minimize the total maximum force. This thus allows the drive, transmission and contact devices to be dimensioned to be smaller.

Further preferred refinements and embodiments of the invention result from the other features.

### BRIEF DESCRIPTION OF THE DRAWINGS

The present invention will become more fully understood from the detailed description of preferred embodiments given hereinbelow and the accompanying drawings, which are given by way of illustration only and thus are not limitative of the present invention, and wherein:

FIG. 1a shows switching poles of a conventional multipole circuit breaker;

FIG. 1b shows switching poles of a multipole circuit breaker with contact devices which make contact at different times;

FIG. 2a shows switching force diagrams for conventional two-pole circuit breakers;

FIG. 2b shows switching force diagrams for multipole circuit breakers with contact devices which make at different times;

FIG. 3 shows a structogram of the mechanism of a three-pole circuit breaker with contact devices which make at different times, and

FIGS. 4a and 4b show angular positions of the joints at the coupling points.

### DETAILED DESCRIPTION OF THE PREFERRED EMBODIMENTS

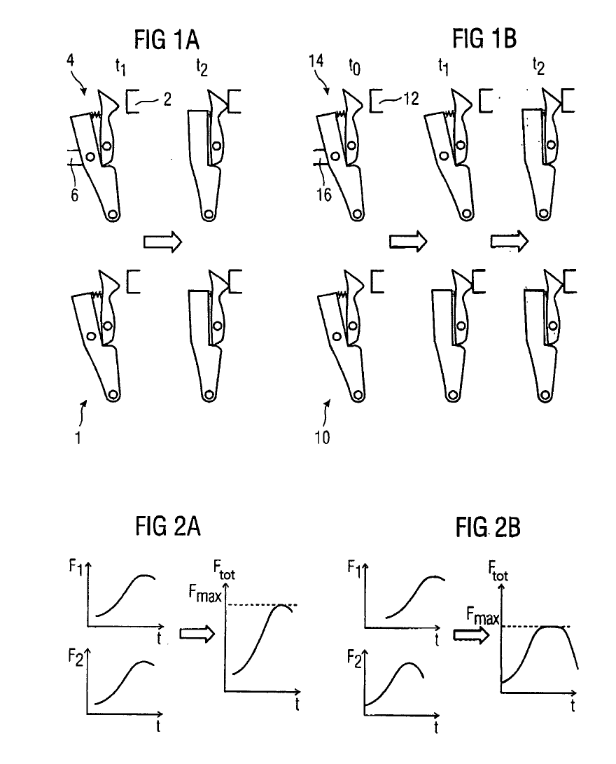

FIG. 1a shows, schematically, the switching principle of a conventional multipole circuit breaker 1 with moving contact devices 4 which make contact at the same time. FIG. 1b shows an embodiment of the present invention including a multipole circuit breaker 10 with moving contact devices 14 which make contact at different times, for comparison. The illustrations in each case show the stationary contact devices 2 and 12 and the respective moving contact devices 4 and 14 for two poles. The respective drive devices 6 and 16 for the respective contact devices 4 and 14 are indicated in FIGS. 1a and 1b, respectively.

In a circuit breaker 1 of the conventional type, as is shown in FIG. 1a, the moving contact devices 4 of the individual switching poles move virtually synchronously and are each in the same relative positions with respect to the stationary contact devices 2, for example at the time t₁. The contacts of the two poles thus make contact at the same time t₂ during the connection process.

The behavior of the exemplary embodiment according to the invention as illustrated in FIG. 1b is different. In this case, the contacts of the second pole make contact at a time t₁, while the contact device 14 for the first pole is still moving. The contacts of the first pole also make contact at a time t₂, so that both current paths are now connected.

FIGS. 2a and 2b show the principle of the addition of the switching forces F₁ and F₂ on two individual poles of a multipole circuit breaker 1 or 10 to produce a total force Fₜₒₜ, which has to be applied by the respective drive device 6 or 16, illustrated schematically on the basis of force/time graphs. A distinction is in this case drawn between a circuit breaker 1 of the conventional type with synchronous switching processes (FIG. 2a) and a circuit breaker 10 of an embodiment of the present invention, with moving contact devices 14 which make contact at different times (FIG. 2b).

As can be seen from FIG. 2a, the two graphs have virtually the same time profile for the individual pole switching forces. The addition of the switch force profiles F₁ and F₂ thus results approximately in twice the individual forces, with a maximum at Fₘₐₓ.

In contrast, in the exemplary embodiment of the invention shown in FIG. 2b, the time switching force profile Fₜₒₜ for the first pole is delayed in time with respect to that of the second pole F₂. The overall profile Fₜₒₜ of the two individual pole switching forces in consequence has a shape which differs from the profile of the individual pole switching forces.

In this specific example, there is a flattened area whose maximum Fₘₐₓ is considerably lower than that in FIG. 2a. Thus, with the circuit breaker 10 whose moving contact devices 14 make contact at different times, the maximum total force Fₘₐₓ which needs to be applied for connection purposes counter to the mechanical and electrodynamic forces is less. This, in the end, allows the drive, transmission, latching and contact devices to be dimensioned to be smaller.

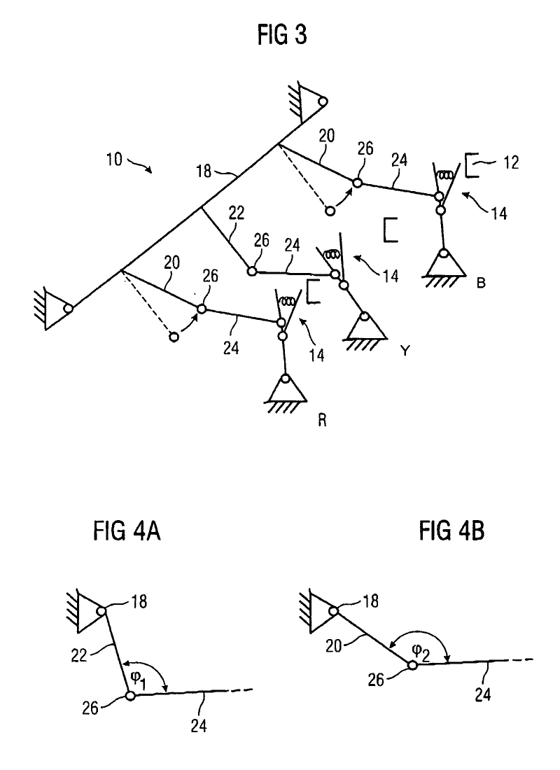

FIG. 3 shows, schematically, the structogram of the mechanism of a three-pole circuit breaker 10 of an embodiment of the present invention, with the current paths R, Y and B. The circuit breaker 10 includes a switching shaft 18 with three switching shaft levers 20, 20 and 22, three moving contact devices 14, three coupling devices 24 in the form of coupling rods of the same length, two outer coupling rods of which are respectively connected to one of the outer switching shaft levers 20 and to one of the moving contact devices 14, and the central, third of which is operatively connected to the central, third switching shaft lever 22 and to the central, third contact device 14, as well as a stationary contact device 12 in each case, for each current path.

The switching shaft levers 20 and 22 have coupling point 26 for coupling of the associated coupling device. The coupling points 26 on the switching shaft levers 20 for the phases R and B are arranged offset with respect to that for the phase Y, in that angular positions which are not the same as those for the switching shaft lever 22 for the phase Y are chosen for the switching shaft levers 20 for the outer phases. A drive torque which acts on the switching shaft 18 is transmitted via the kinematic chain to the moving contact devices 14.

During the connection process, the moving contact devices 14 move towards the stationary contact devices 12. During this process, the contact device 14 for the phases R and B leads that for the phase Y owing to the different position of the coupling point 26 on the switching shaft levers 22. The contacts on the phase Y thus also make with a time delay. The different angular positions of the joints at the coupling points 26 also results in the drive being released more easily at the time of connection. This advantageously results in a higher switching shaft speed at the time at which the contacts make, and thus in an improved switching capacity.

FIGS. 4a and 4b show, schematically, the angular positions φ₁ and φ₂ of the joint at the coupling point 26 of the switching shaft lever 22 (FIG. 4a) and at the coupling point 26 (FIG. 4b) of the switching shaft lever 20 at the time at which the circuit breaker 10 is connected. The change in position of the coupling point 26 on the switching shaft lever 22 with respect to the coupling points 26 of the switching shaft levers 20 has been achieved by changing the angular position φ₂ of the switching shaft lever 20 in FIG. 4b in comparison to that of the switching shaft lever 22 on the switching shaft 18, with the switching shaft lever 20 on the coupling rods 24 having the same length. This therefore results in a more obtuse angle φ₂ in FIG. 4b between the switching shaft lever 20 and the coupling device 24 in comparison to the angle φ₁ in FIG. 4a between the switching shaft lever 22 and the coupling device 24.

For the same forward movement of the coupling device 24 in FIG. 4b, the torque which has to be overcome by the drive of the switching shaft and which results from the total force of the switching pole is less than in FIG. 4a. This results in the drive being released more easily at the time of connection, resulting in a reduction in the required drive energy. This allows the drive, transmission, latching and contact devices to be dimensioned to be smaller. The simplified release also leads to a higher switching shaft speed at the time at which the contacts make contact. This results in an improved connection capacity with regard to electrodynamic current loop forces.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A circuit breaker, comprising:
at least two stationary contact devices;
at least two movable contact devices; and
at least one drive device, wherein the at least one drive device is operatively connected to the at least two movable contact devices, and wherein contact-making between at least one stationary contact device and at least one movable contact device and contact-making between at least one other stationary contact device and at least one other movable contact device take place at different times during the connection process. cm 2. The circuit breaker as claimed in claim 1, wherein the drive device includes a switching shaft. cm 3. The circuit breaker as claimed in claim 2, wherein the switching shaft includes at least one switching shaft lever, connected to the switching shaft. cm 4. The circuit breaker as claimed in claim 3, wherein the drive device includes at least two coupling devices, each being operatively connected to one of the switching shaft levers and to one of the movable contact devices. cm 5. The circuit breaker as claimed in claim 4, wherein at least one coupling device includes at least one coupling rod. cm 6. The circuit breaker as claimed in claim 4, wherein the coupling points of the at least one switching shaft lever for coupling of the coupling devices are in mutually different positions with respect to the switching shaft axis. cm 7. The circuit breaker as claimed in claim 4, wherein the coupling points to the coupling device of all the switching shaft levers are in the same position with respect to the switching shaft axis. cm 8. The circuit breaker as claimed in claim 5, wherein all of the coupling rods have the same length. cm 9. The circuit breaker as claimed in claim 5, wherein at least two coupling rods have mutually different lengths. cm 10. The circuit breaker as claimed in claim 1, wherein the circuit breaker includes a three-pole configuration. cm 11. The circuit breaker as claimed in claim 1, wherein the circuit breaker includes a four-pole configuration. cm 12. The circuit breaker as claimed in claim 1, wherein the times at which the contacts of the three poles make contact during the connection process are different to one another. cm 13. The circuit breaker as claimed in claim 1, wherein the times at which the contacts of all of the poles make contact during the connection process are different from one another. cm 14. The circuit breaker as claimed in claim 5, wherein the coupling points of the at least one switching shaft lever for coupling of the coupling devices are in mutually different positions with respect to the switching shaft axis. cm 15. The circuit breaker as claimed in claim 5, wherein the coupling points to the coupling device of all the switching shaft levers are in the same position with respect to the switching shaft axis. cm 16. The circuit breaker as claimed in claim 14, wherein all of the coupling rods have the same length. cm 17. The circuit breaker as claimed in claim 15, wherein all of the coupling rods have the same length. cm 18. The circuit breaker as claimed in claim 14, wherein at least two coupling rods have mutually different lengths. cm 19. The circuit breaker as claimed in claim 15, wherein at least two coupling rods have mutually different lengths. cm 20. A circuit breaker, comprising:
at least two stationary means for making contact;
at least two movable means for making contact; and
at least one drive means, operatively connected to the at least two movable contact devices, for driving at least one movable means to contact at least one stationary means and for driving at least one other movable contact device to contact at least one other stationary contact device, wherein each contacting takes place at a different time during the connection process.
